(19) United States
(12) Patent Application Publication
(10) Pub. No.: US 2020/0200282 A1
(43) Pub. Date: Jun. 25, 2020

(54) Integrated Control Solenoid Assemblies

(71) Applicant: KG Squared LLC dba APW Company, Rockaway, NJ (US)

(72) Inventors: David Hans Promnitz, Newfoundland, NJ (US); Jason Kellenberger, Sparta, NJ (US); Akos Sule, Roseland, NJ (US)

(73) Assignee: KG Squared LLC dba APW Company, Rockaway, NJ (US)

(21) Appl. No.: 16/231,500

(22) Filed: Dec. 22, 2018

(51) Int. Cl. F16K 7/04; F16K 31/06

(52) U.S. Cl. CPC F16K 7/045; F16K 31/0641

(57) ABSTRACT

A solenoid assembly is provided including a housing having a cavity; an enclosure mounted on the housing; an electricity conducting coil surrounding a tubular passageway traversed by a vertical axis, the coil arranged within the cavity; an armature assembly moveable from a first to a second position being forced by a temporary magnetization; a circuit board oriented perpendicular to the vertical axis and at least partially covered underneath the enclosure, the board including a logic circuit and a power regulating circuit.

### BACKGROUND OF THE INVENTION

### Field of the Invention

The invention concerns solenoid assemblies integrally fitted with power control drivers, programmable microprocessors and visual activation state indicators.

### The Related Art

Among the leading commercial solenoid-controlled valves are those sold by NResearch Inc. These are described in the following patents: US Re 34,261E; U.S. Pat. Nos. 4,711,269; 5,143,118; and 5,549,987. A variant type are the pinch valve assemblies described in the following patents: U.S. Pat. Nos. 4,496,133; 4,993,456; and 5,190,071A. All the aforementioned patents identify Akos Sule as inventor.

Normally, scientists, engineers and other users of commercial solenoid-controlled valves will connect them to a programmed computer. Thereby timing and selection of fluid feed rates may be regulated for a particular use. With heat sensitive fluids, users may need to reduce heat generated from valve operation. Lower power consumption may also be economically desirable. In these instances, a driver is wired into the computer. Current can then be reduced by as much as one-third the original level. Not all users are sufficiently knowledgeable about benefits of drivers or their installation.

A further problem is the need of users for confirmation that valves are working properly.

Still further is the need for easy electrical connection between solenoids, drivers, and programmed computers.

### SUMMARY OF THE INVENTION

A solenoid assembly is provided which includes:
a housing having a cavity; an enclosure mounted on an upper end of the housing;
an electricity conducting coil surrounding a tubular passageway, a vertical axis traversing a length of the passageway, the coil being arranged within the cavity of the housing;
an armature assembly including an armature plate, the armature assembly being moveable from a first position to a second position, movement from the first to the second position being forced by a temporary magnetization of the armature plate; and
a circuit board having major upper and lower surfaces, the board being oriented perpendicular to the vertical axis and at least partially covered underneath the enclosure, and the board including a logic circuit and a power regulating circuit, the logic circuit functioning to activate the coil and the power regulating circuit functioning to reduce heat by periodic downward cycling of average electric power input levels.

In some embodiments, the circuit board may further include a back electromotive force circuit functioning to protect against any collapsing magnetic field that might induce a reverse voltage spike. Furthermore, in some embodiments the circuit board may include a visual indicator to report whenever a valve coupled to the solenoid assembly has activated and thereafter to report a drop in the average electric current input levels.

### BRIEF DESCRIPTION OF THE DRAWING

More features and aspects of the present invention can best be understood by reference to the accompanying drawing in which:

FIG. 1 is a perspective view of a solenoid assembly mounted on a valve body;

FIG. 2 is an exploded cross-sectional view of the solenoid assembly in accordance with one embodiment of the invention;

FIG. 3 is a cross-sectional collapsed view of the solenoid assembly shown in FIG. 2;

FIG. 4 is a plan view of a major lower surface of the circuit board incorporated into the solenoid assembly;

FIG. 5 is a plan view of a major upper surface (mirror image) of the circuit board shown in FIG. 4: and

FIG. 6 is a cross-sectional view of a solenoid assembly and valve assembly.

### DETAILED DESCRIPTION OF THE INVENTION

Now we provide improvements which overcome the problems of the known art. These improvements encompass integrating into a single board, held within confines of an enclosure located on a solenoid, one or more of the following circuits: a logic circuit to activate a coil inducing movement of the armature assembly; a power regulating circuit to internally reduce heat by altering average electric current input levels; a visual indicator to report whenever a valve coupled to the solenoid assembly has activated and to report a drop in applied average electric current input levels and length of time thereof; a back electromotive force (EMF) protection circuit to counter any collapsing magnetic field; and an integrated connection.

Drivers to accomplish the several circuit functions are built directly into the integrated circuit scribed upon the single board. These drivers can be activated by a simple logic signal. The circuit utilizes a current synchronizing trigger which allows the drivers to interface with a broad range of devices. Drivers can be activated with a logic level zero from an external microcontroller or logic driven device or even activated with a simple switch by synchronizing the trigger to a logic signal.

The power regulating circuit is a particularly useful feature. The integrated driver for this circuit turns on for a short period at its full power rating. Then the average electric current input level is dropped to a lower holding power level. This allows a valve to activate reliably while simultaneously keeping the solenoid from over heating. Maintenance of cooler temperatures prolongs the life of the solenoid. The cooling effect allows designers to use solenoid valves where traditionally heat sensitive flow media would have been restricted.

Back EMF protection is provided when the solenoids are turned off. Any collapsing magnetic field that induces a reverse voltage spike can damage sensitive electronics. Drivers counter this effect preventing the reverse voltage spike from getting to the sensitive electronics. By having the driver built into the single circuit board, designer users no longer need to build their own protective circuitry. The valve can simply be fed power, ground and a trigger signal to function.

A visual indicator is built into the solenoid system to display its state. In one embodiment, the visual indicator is a light whose illumination indicates to an observer that the valve has activated. Thereafter, the illumination dims to indicate the average electric current has dropped to a holding level. In certain embodiments, a second light having a different color output can identify the position of the armature shaft/plate or the mechanical position of the solenoid independent of the coil state. With light it becomes easy to see exactly which valves are activating, their period of activation, and timing. In still a further embodiment, the visual indicator can, if so required, be programmed not to indicate.

Integrated connections provide further benefits. In certain embodiments, the solenoid systems are fitted with contact pins rather than flying leads. A contact pin may include a three-wire terminal providing power, grounding and valve trigger. Herein the contact pins allow the valve to be easily replaced should the design of the parent device ever need to be updated or repaired. Secondly, valves need no longer be hardwired into a system or have separate termination applied. This minimizes the needed number of system connections. Finally, in certain embodiments moveable components, such as the armature plate, are movement enabled by the presence of a through going opening. This opening permits up/down travel around the coil interface.

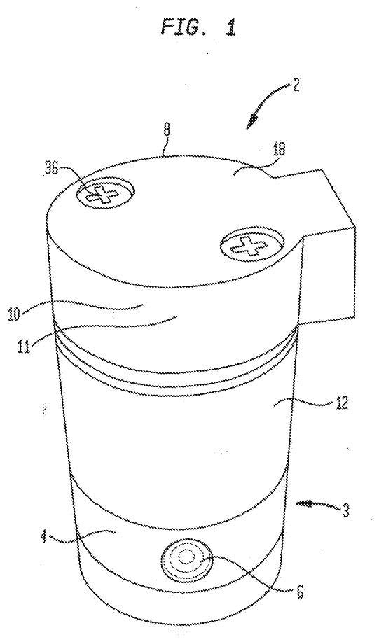

FIG. 1 illustrates one embodiment of the solenoid assembly 2 mounted on a valve body 3 housing a valve assembly 4. Fluid (i.e. liquid or gaseous) media in/out ports 6 traverse an exterior wall of the valve body. Enclosure 8 is seated on one end of the solenoid assembly protectively covering circuit board 10. In certain embodiments, the enclosure may be formed of either a translucent or transparent plastic. A light 11 mounted on the circuit board is activated /deactivated synchronously with state changes in the system. By observing the frequency of the flashing light, an observer is informed of mechanical movements or electrical state in the solenoid assembly.

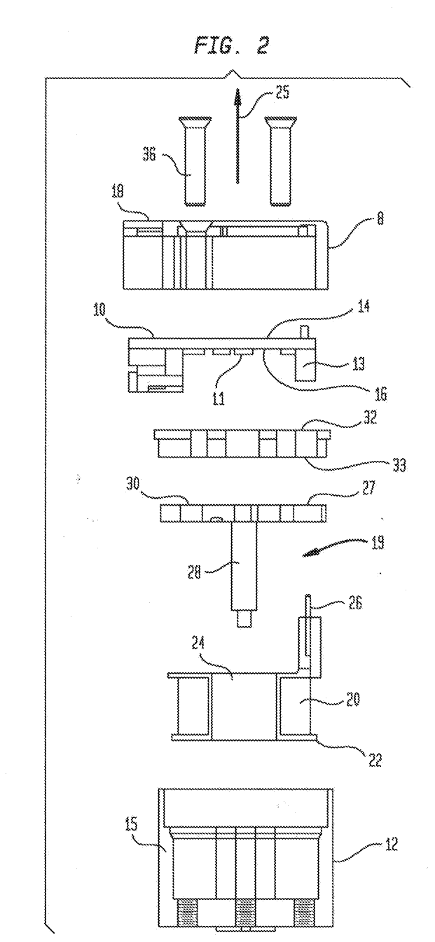

In FIG. 2 the circuit board rests above a housing 12, the circuit board having major upper and lower surfaces 14,16 respectively being oriented parallel to an outer top surface 18 of the enclosure. A connector 13 sited on the lower surface of the circuit board provides direct connection between functions on the board and the coil 20.

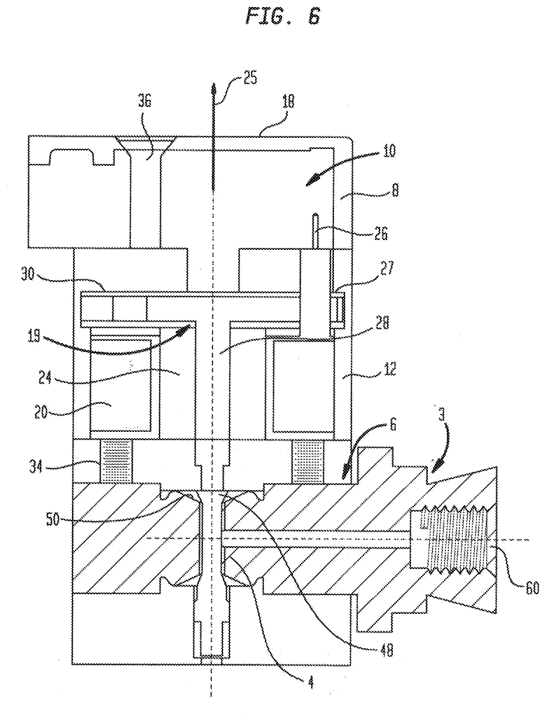

FIG. 2 illustrates the relationship of components within the cavity 15 of housing 12 and with the enclosure and circuit board. Coil 20 holds layers of electrically conductive wire tightly wound around a spool 22. Interior to the spool is a tubular passageway 24 traversed by a vertical axis 25 oriented along a length of the passageway. One or more electricity conducting contact pins 26 are mounted rigidly perpendicular to and electrically communicating between the coil and circuit board. In the shown embodiments of FIGS. 2 and 6, moveable components, such as armature plate 30, are enabled via a through-going opening 27 to travel up/down around a connection to the coil.

The drawn embodiments illustrate 3-way configurations. These configurations include an armature shaft 28 perpendicularly connected to the armature plate, the shaft being vertically moveable within the tubular passageway 24. The alternative 2-way configurations have only an armature plate attached to a diaphragm or poppet. In pinch valve embodiments, the shaft is attached directly to the armature plate.

Armature plate 30 is formed of a magnetic ferrous material attractable to the coil during periods wherein the coil generates a magnetic field. Top plate 32 is seated above and adjoins the plate. Aperture 33 formed in the top plate allows upward/downward movement around the contact pins 26.

A set of threaded bores 34 serve as mounting means to connect valve bodies to the solenoid assembly.

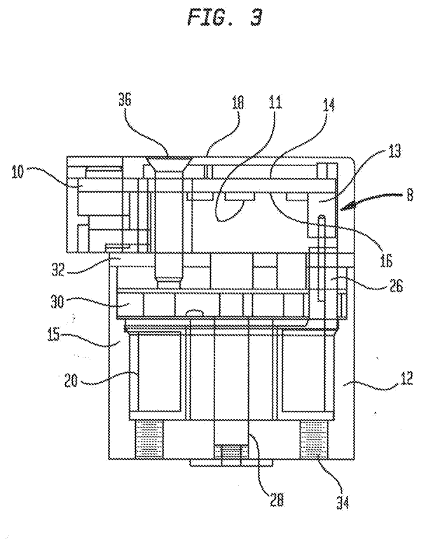

FIG. 3 illustrates the coil, spool and armature assembly in a fully assembled arrangement. Mounting fasteners 36 secure the enclosure and the circuit board to the top plate and thereby also hold in-place the housing containing the coil, spool and armature assembly.

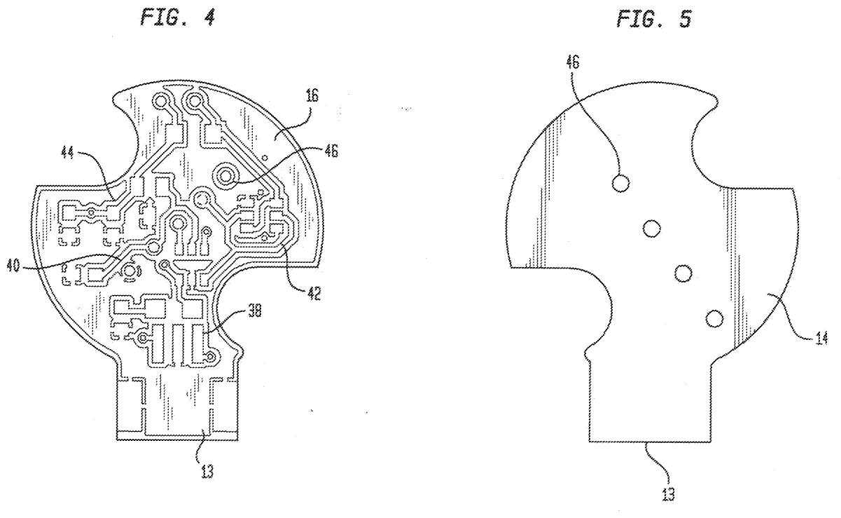

FIGS. 4 and 5 reveal various aspects of the circuit board 10. These aspects include a logic circuit 38, a power regulating circuit 40, a back electromotive force protection circuit 42 and an LED circuit 44.

One or more connection interfaces 46 which may be ports arranged on the upper surface of the circuit board connecting with the circuits on the lower surface. The connection interfaces allow electrical connection with an external controller having a program for reprogramming elements of the circuit board. Interfaces 46 are illustrated in FIG. 4 as five in number. However, in some embodiments the number may range from one to twenty or more.

FIG. 6 illustrates in cross-section the solenoid assembly and relationship with the valve assembly 4. Within the valve assembly is a diaphragm mechanism with a spherical ball 48 disposed in a seat 50. Fluid requiring flow control enters the valve assembly via a conduit 60.

While the invention has been described with reference to specific embodiments, it should be understood that numerous modifications and variations are possible and are to be regarded as within the scope and spirit of this invention.

What is claimed is:

1. A solenoid assembly comprising:
a housing having a cavity;
an enclosure mounted on an end of the housing;
an electricity conducting coil surrounding a tubular passageway, a vertical axis traversing a length of the passageway, the coil being arranged within the cavity of the housing;
an armature assembly comprising an armature plate, the armature assembly being moveable from a first position to a second position, movement from the first to the second position forced by a temporary magnetization of the armature plate; and
a circuit board having major upper and lower surfaces, the board being oriented perpendicular to the vertical axis and at least partially covered underneath the enclosure, and the board including a logic circuit and a power regulating circuit, the logic circuit functioning to activate the coil and the power regulating circuit functioning to reduce heat by periodic downward cycling of average electric current input levels.

2. The solenoid assembly according to claim 1 further comprising a visual indicator which reports whenever a valve coupled to the solenoid assembly has activated.

3. The solenoid assembly according to claim 2 wherein the visual indicator is a light which flashes upon each change of the average electric current input levels.

4. The solenoid assembly according to claim 1 wherein the enclosure is formed of rigid or semi-rigid materials.

5. The solenoid assembly according to claim 1 wherein the major upper and lower surfaces are oriented parallel to an outer top surface of the enclosure.

6. The solenoid assembly according to claim 1 further comprising a set of one or more electricity conducting contact pins mounted rigidly parallel to the vertical axis, electrically connecting the circuit board to the con, and arranged within the enclosure.

7. The solenoid assembly according to claim 6 wherein the armature plate features a through-going opening allowing the armature plate to be vertically moveable around at least one of the contact pins.

8. The solenoid assembly according to claim 1 wherein the circuit board has one or more plurality connection interfaces on the major upper surface, the connection interfaces allowing electrical connection with an external controller having a program for reprograming elements of the circuit board.

9. A circuit board for interacting with a solenoid assembly comprising:
a logic circuit functioning to activate movement within a solenoid assembly;
a power regulating circuit functioning to control applied average electrical current to the solenoid assembly; and
a back electromotive circuit functioning to protect against any collapsing magnetic field that might induce a reverse voltage strike.

10. The circuit board according to claim 9 further comprising a plurality of connection interfaces on a major upper surface of the board, the interfaces allowing electrical connection with an external control device having a program for reprograming elements of the circuit board.

11. The circuit board according to claim 9 further comprising a light to flash whenever a valve coupled to the solenoid assembly has been activated and thereafter dimming to indicate a drop of electrical current.
